(19) United States
(12) Patent Application Publication
(10) Pub. No.: US 2022/0125013 A1
(43) Pub. Date: Apr. 28, 2022

(54) MEDICAL PET GARMENT

(71) Applicant: Andrew Christian Reist, Springfield, MA (US)

(72) Inventor: Andrew Christian Reist, Springfield, MA (US)

(21) Appl. No.: 17/569,583

(22) Filed: Jan. 6, 2022

Related U.S. Application Data
(63) Continuation-in-part of application No. 29/690,493, filed on May 8, 2019, now Pat. No. D943838.

(51) Int. Cl. A01K 13/00

(52) U.S. Cl. CPC A01K 13/006

(57) ABSTRACT

The present disclosure relates to a Medical Pet Garment designed to encase and protect a pet's torso area, in particular a quadruped pet that underwent a medical procedure. The Medical Pet Garment comprises an upper torso portion and a hindquarters flap. The upper torso portion is designed to substantially cover a pet's torso and comprises a top part which substantially covers a pet's back and a bottom part which substantially covers a pet's chest. The hindquarters flap extends from the bottom part opposite to the neck opening. When the Medical Pet Garment is worn by a pet, the hindquarters flap may be positioned over the pet's abdomen and rump and secured in this position by a releasable attachment to the top part. To allow the pet to relieve itself, a user has to simply release the hindquarters flap from the top part and uncover the pet's abdomen and rump. A user may then lay the hindquarters flap against the bottom part of the upper torso portion and releasably secure it there.

### TECHNICAL FIELD

The presently disclosed subject matter relates generally to a Medical Pet Garment designed to protect a pet's torso area, particularly a pet's abdomen area, and in particular in a pet that underwent a medical procedure or is undergoing a medical treatment.

### BACKGROUND

The present disclosure relates to a Medical Pet Garment, in particular a Medical Pet Garment for a quadruped pet. Some of the most common veterinarian procedures performed on quadruped pets, such as dogs and cats, are neutering or spaying, thus affecting most pets' owners. While the procedures are practically a routine, caring for pets after surgery has long been a challenge for owners. Pets, most commonly dogs and cats, often have an irresistible instinct to lick, scratch, or otherwise access and irritate the wound site and thus possibly infect it. This may delay the healing of the wound and ultimately jeopardize the overall health of the animal.

A traditional method in the field which is used to prevent an access to a wound is the cone (Elizabeth collar) which partially encircle the pet's head and prevents it from grooming or licking its body. However, the cone also restricts the animal field of vision, and makes eating, drinking, or even simply lying down uncomfortable for the pet. Several cone alternatives in the art include a pet body suit, for example, an almost complete body cover (US20080264351A1) or a suit which covers a pet's torso (U.S. Pat. No. 9,258,981B2). Both suits encase the animal's torso and are secured around the pet's body by securing means positioned along the suit portion which rests on the animal's back. However, neither suit offers a solution, other than completely removing the suit, as to how to expose the animal's hindquarters to allow it to relieve itself. This presents a huge burden for the pet's owner who has to repeatedly dress and undress an often-reluctant and irritated pet. Another suggested alternative is a vest-like pet garment (JP3224600U) which encases a pet's chest and part of a pet's back; however, it does not provide a secure cover for the lower abdomen and, therefore, does not offer a much-needed protection for pets undergoing spaying or neutering.

There is a need in the field for a Medical Pet Garment which protects an animal's torso area, in particular when the pet is recovering from a medical condition or a medical procedure, while enabling a user to easily expose the animal's rump and abdomen as needed without the need to remove the entire garment, and optionally, provides a possibility to sooth, pad, or medicate the wound/treated area, or allow the animal to relieve itself.

### SUMMARY

In accordance with the present invention, various embodiments of the Medical Pet Garment and methods of use thereof are disclosed. In one embodiment, the present disclosure provides a medical pet garment for a quadruped pet comprising an upper torso portion and a hindquarters flap. The upper torso portion is designed to substantially cover a back and a chest of a pet. The upper torso portion generally comprises a bottom part and a top part, wherein the bottom part and the top part formed as one piece. The bottom part substantially covers the chest of a pet and the top part substantially covers the back of a pet. The upper torso portion comprises a neck opening designed to receive a neck of a pet, and at least one front leg opening designed to receive at least one front leg of a pet. The hindquarters flap extends from an end of the bottom part distal, and opposite, to the neck opening. The upper torso portion further comprises at least one attachment means positioned substantially at an end of the top part distal, and opposite, to the neck opening and the hindquarters flap comprises at least one attachment means positioned substantially at an end of the hindquarters flap distal to the bottom part.

The hindquarters flap is designed to be positioned over a pet's abdomen, in between a pet's hindlegs, and over a pet's rump, and releasably attach via the at least one hindquarters flap's attachment means to the upper torso portion's at least one attachment means, thereby covering a pet's abdomen and rump.

An inner side of the Medical Pet Garment is the side facing the pet's body when the Medical Pet Garment is worn by a pet.

In some embodiment, the bottom part further comprises at least one attachment means positioned proximal to the neck opening. The hindquarters flap is further designed to be positioned against the bottom part in such manner that an outer surface of the hindquarters flap is positioned flat against an outer surface of the bottom part. The hindquarters flap can then be releasably attach via the hindquarters flap's at least one attachment means to the said at least one attachment means positioned proximal to the neck opening, thereby leaving the pet's abdomen and rump exposed.

In some embodiments, the hindquarters flap further comprises a tail opening designed to receive a pet's tail.

In some embodiments, the hindquarters flap comprises at least two sets of attachment means, and each set comprises at least one attachment means designed for releasable attachment to the top part. Preferably, each set is positioned at a different, predetermined, distance from the end of the hindquarters flap distal to the bottom part. When the Medical Pet Garment is worn by a pet, each set, from closest to farthest from the said end of the hindquarters flap, when used to releasably attach the hindquarters flap to the top part, defines a different size of the Medical Pet Garment, from biggest to smallest, respectively.

In some embodiments, the bottom part comprises one attachment means positioned proximal to the neck opening, and the top part comprises two attachment means positioned substantially at the end of the top part distal to the neck opening.

In some embodiments, the hindquarters flap comprises two sets of attachment means designed for releasable attachment to the top part, wherein each set is positioned at a different, predetermined, distance from the end of the hindquarters flap distal to the bottom part, and wherein each set comprises two attachment means. Further, the hindquarters flap further comprises one attachment means designed for releasable attachment to the bottom part's attachment means positioned proximal to the neck opening.

In some embodiments, the Medical Pet Garment further comprises a closable pocket positioned on its inner surface.

In some embodiments, the pocket is positioned substantially on the inner surface of the hindquarters flap.

In some embodiments, the attachment means is selected from a group comprising hook or loop fasteners, hook and eye fasteners, zippers, studs, fastening buttons and complementary button holes, straps with longitudinally spaced holes and corresponding buckles, snap buttons, and combinations thereof.

A method of using the Medical Pet Garment comprises the steps of:
(a) passing a pet's head through the neck opening and positioning the top part at the pet's back and the bottom part at the pet's chest;
(b) passing each pet's front legs through the at least one front leg opening;
(c) positioning the hindquarters flap over the pet's abdomen and in between the pet's hindlegs;
(d) passing a pet's tail through the tail opening;
(e) releasably attaching a set of the hindquarters flap's attachment means to the top part's two attachment means; and,
(f) when desired, releasing the hindquarters flap from the top part's two attachment means and releasably attaching the hindquarters flap to the bottom part's attachment means positioned proximal to the neck opening, thereby exposing the pet's abdomen and rump.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 illustrates a top view of an example of the Medical Pet Garment laid flat and in an open configuration;

FIG. 2 illustrates a bottom view thereof;

FIG. 3 illustrates a top view of the example of FIG. 1 wherein the top part is partly folded to expose a pocket;

FIG. 4 illustrates a perspective view of the example of FIG. 1 when in use and in a first closed configuration;

FIG. 5 illustrates a perspective view of the example of FIG. 1 when in use and in an open configuration;

FIG. 6 illustrates a top view of the example of FIG. 1 when laid flat in a first closed configuration;

FIG. 7 illustrates a top view of the example of FIG. 1 when laid flat in a second closed configuration;

FIG. 8 illustrates a perspective view of the example of FIG. 1 when in a first closed configuration; and,

FIG. 9 illustrates a bottom view of the example of FIG. 1 laid flat wherein a hindquarters flap lays against the bottom part.

### DETAILED DESCRIPTION

The presently disclosed subject matter now will be described more fully hereinafter with reference to the accompanying Drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Drawings. Therefore, it is to be understood that the presently disclosed subject matter is not to be limited to the specific embodiments disclosed and that modifications and other embodiments are intended to be included within the scope of the appended claims.

In some embodiments, the presently disclosed subject matter provides a Medical Pet Garment designed to encase and protect a pet's torso area, in particular a pet which underwent a medical procedure, while allowing the pet a free movement. In a preferred embodiment, the presently disclosed Medical Pet Garment is designed for quadruped pets. Examples of quadruped pets include, but are not limited to, dogs and cats. The presently disclosed Medical Pet Garment enables a user to easily and substantially expose the animal's abdomen and rump as needed without the need to entirely remove the Medical Pet Garment. In some embodiments, the Medical Pet Garment provides a possibility to sooth, pad, or medicate the wound/treated area.

More specifically, according to one example, the Medical Pet Garment comprises an upper torso portion and a hindquarters flap. The upper torso portion is designed to substantially cover an upper torso (a back and a chest) of a pet and comprises a neck opening designed to receive a neck of the pet. The upper torso portion comprises a bottom part and a top part, the bottom part substantially covers the chest of a pet and the top part substantially covers the back of a pet. Additionally, In some embodiments, the upper torso portion comprises two front leg openings designed to receive front legs of the pet. In some embodiments, the hindquarters flap extends from an end of the bottom part which is distal and opposite to the neck opening. In some embodiments, the hindquarters flap comprises a tail opening and at least one attachment means positioned substantially at an end of the hindquarters flap which is distal to the bottom part. The top part of the upper torso portion comprises at least one attachment means positioned substantially at its end which is distal to the neck opening. The hindquarters flap can be passed, by a user, in between the pet's hindlegs and releasably attach to the top part's attachment means, thus covering the pet's abdomen and rump. Alternatively, a user can release the hindquarters flap from its attachment to the top part, move it towards the pet's chest, and lay it flat against the bottom part. The hindquarters flap can then be secured in this position by a releasable attachment to an attachment means positioned on the bottom part, proximal to the neck opening, thereby the pet's abdomen and rump are left exposed.

A user employs the Medical Pet Garment by passing the pet's head through the neck opening and orienting the Medical Pet Garment so that the top is positioned at the pet's back. The user than passes the pet's front legs through the front legs opening and the Medical Pet Garment can be stretched/smoothed on the pet's body to cover the torso. If the user desires to cover the pet's abdomen and rump, he/she passes the hindquarters flap in between the pet's hindlegs and releasably secure it to the top part. When the hindquarters flap is releasably secured to the top part in such a manner the Medical Pet Garment is in a closed configuration. To expose the animal's hindquarters to allow the animal (the terms “animal” and “pet” are used interchangeably herein) to relive itself or to enable the user to attend to a wound or a treated area, the user has to simply detach the hindquarters flap from the top part, swing it to the direction of the pet's chest. The user may then lay hindquarters flap flat against the bottom part. Conveniently, the user can easily secure the hindquarters flap the bottom part in this position. When the hindquarters flap is releasably secured to the bottom part in such a manner the Medical Pet Garment is in an open configuration

Therefore, the Medical Pet Garment presents an easy and convenient option for pet's owners when caring for animals for which covering and protecting the torso area is beneficial to recovery or well-being. Importantly, for pets, the Medical Pet Garment offers a comfortable alternative to the Elizabeth collar and a chance for a stress-free recovery.

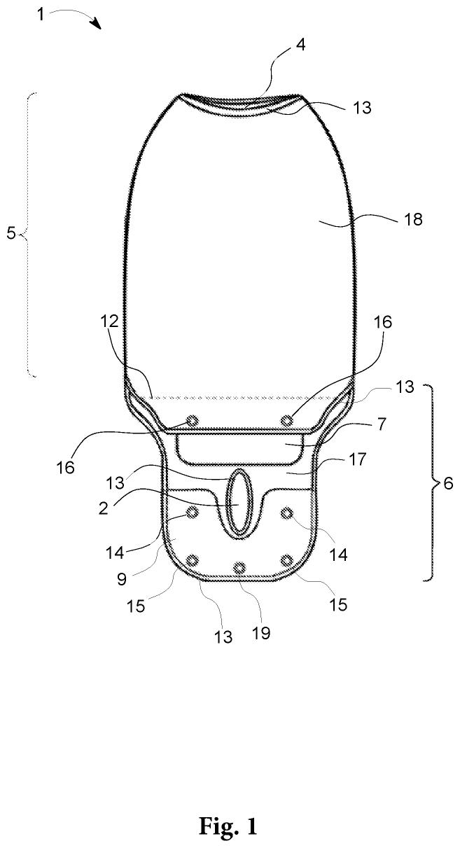

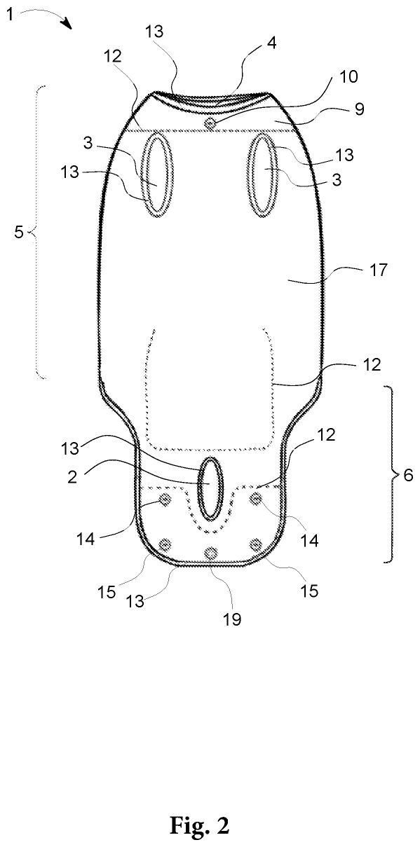

Referring now to FIGS. 1 and 2, a top view and a bottom view, respectively, of an example of the Medical Pet Garment 1 laid flat and in an open configuration are illustrated. Generally, the presently disclosed Medical Pet Garment 1 comprises an upper torso portion 5 and a hindquarters flap 6. The upper torso portion 5 is designed to substantially cover a torso of a pet and comprises a bottom part 17 and a top part 18. The bottom part 17 substantially covers the chest of a pet and the top part 18 substantially covers the back of a pet. The bottom part 17 and the top part 18 are continuously formed as one piece. In some embodiments, the bottom part 17 and the top part 18 are fashioned as one piece, while in other embodiments the bottom part 17 and the top part 18 are attached together to form one piece, for example by sewing them together, however, any method known in the art for attaching pieces of fabrics/knits together may be employed for this purpose.

The upper torso portion 5 comprises a neck opening 4 for passing a head of a pet through it and receiving the pet's neck. Additionally, the upper torso portion 5, comprises at least one front let opening 3 designed to receive a pet's front legs. In some embodiment, the upper torso portion 5 comprises two front leg openings 3. However, in some other embodiments (not shown), the upper torso portion 5 comprises one front leg opening 3 shaped to receive two front legs of a quadruped pet.

In some embodiments, when laid flat as illustrated in FIGS. 1 and 2, the bottom part 17 and the top part 18 substantially overlap. In some embodiments, the hindquarters flap 6 extends from an end of the bottom part 17 which is distal, and opposite, to the neck opening 4. In some other embodiments, the hindquarters flap 6 extends substantially from the end of the bottom part 17 which is distal and opposite to the neck opening 4, and also partly from the end of top part 18 proximal to the said end of the bottom part 17. Essentially, the area of the Medical Pet Garment 1 in which the bottom part 17 and the hindquarters flap 6 meet serves as a hinge, allowing a user to swing/move the hindquarters flap 6 from a closed configuration to an open configuration, and vice versa.

In some embodiments, the hindquarter flap 6 comprises at least one attachment means 19, 14, 15. In some embodiments, the hindquarter flap 6 comprises at least one attachment means 14, 15 designed for releasable attachment to at least one attachment means 16 which is positioned on the top part 18, and at least one attachment means 19 designed for releasable attachment to at least one attachment means 10 positioned on the bottom part 17.

Generally, the top part's attachment means 16 are positioned substantially at an end of the top part 18 which is distal and opposite to the neck opening 4. In some embodiments, the top part's attachment means 16 are positioned substantially on a portion of the top part 18, distal and opposite to the neck opening 4, which forms a rounded edge portion of the top part 18 (illustrated in at least the examples of FIGS. 1-2). In some embodiments, the hindquarter flap 6 comprises at least two sets of attachment means 14, 15 designed for releasable attachment to attachment means 16. In some embodiments, each set comprises at least one attachment means 14, 15. When the Medical Pet Garment is in use, one of the said sets of the at least two sets of attachment means 14, 15 can be used by a user for releasable attachment to attachment means 16. To facilitate the releasable attachment of each set of the at least two sets of attachment means 14, 15 to attachment means 16, the number of attachment means 14, 15 in each set corresponds to the number of attachment means 16.

In some embodiments, the hindquarter flap 6 comprises 2, 3, 4, 5, or more sets of attachment means 14, 15. In some embodiments, each set of attachment means 14, 15 comprises 1, 2, 3, 4, 5, 6, or more attachment means 14, 15.

In some embodiments, each set of attachment means 14, 15 is positioned at a different, predetermined, distance from the end of the hindquarters flap 6 which is distal to the bottom part 17.

In the example illustrated in FIGS. 1 and 2, the hindquarter flap 6 comprises two sets of attachment means 14, 15, each comprising two attachment means 14, 15. A first set, illustrated, is positioned proximal to the end of the hindquarters flap 6 which is distal to the bottom part 17 and comprises attachment means 15. A second set is positioned further from the end of the hindquarters flap 6 which is distal to the bottom part 17 and comprises attachment means 14. When the first set is used to releasably attach the hindquarters flap 6 to the top part 18 it defines a maximal closed size of the Medical Pet Garment 1, while when the second set is used to releasably attach the hindquarters flap 6 to the top part 18 it defines a smaller closed size of the Medical Pet Garment 1.

In yet some other embodiments (not shown), the top part 18 comprises more than one set of attachment means 16, wherein each set of attachment means 16 is positioned at a different, predetermined, distance from the end of the top part 18 which is distal and opposite to the neck opening 4. According to this embodiment, releasably attaching the hindquarter flap to attachment a set of means 16 which is proximal to the end of the top part 18 which is distal to the neck opening 4 defines a bigger closed size of the Medical Pet Garment 1, while releasably attaching the hindquarter flap to a set of attachment means 16 which is less proximal to the end of the top part 18 which is distal to the neck opening 4 defines a smaller closed size of the Medical Pet Garment 1.

When it is desired to leave the abdomen and rump of a pet wearing the Medical Pet Garment exposed, a user may releasably attach the hindquarters flap 6 to the bottom part 17 using the at least one attachment means 19 and the at least one attachment means 10. In some embodiments, the Medical Pet Garment, comprises 1, 2, 3, 4, 5, 6, or more attachment means 19. Since, the at least one attachment means 19 are designed for a releasable attachment to the at least one attachment means 10, the number of attachment means 19 corresponds to the number of attachment means 10.

According to the example illustrated in FIGS. 1 and 2, the Medical Pet Garment 1 comprises one attachment means 19 positioned proximal to the end of the hindquarters flap 6 which is distal to the bottom part 17, and one attachment means 10 positioned on the bottom part 17, and proximal to the neck opening. In the example shown, attachment means 19 and 10, in their respective positions, are substantially at a symmetry line of the bottom part 17 and hindquarters flap 6. Thus, when the hindquarters flap 6 is releasably attached to the bottom part 17, it is secured in position between the pet's front legs without causing discomfort or pressing on the front legs.

The attachment means 14, 15, 19, 16, 10 of the present disclosure are generally attachment means designed for a releasable attachment, and may be any releasable attachment means traditional in the art. The attachment means 14, 15, 19, 16, 10 of the present disclosure may be, without limitation, hook or loop fasteners, hook and eye fasteners, zippers, studs, fastening buttons and complementary button holes, straps with longitudinally spaced holes and corresponding buckles, snap buttons (shown in the example of FIGS. 1-9), and combinations thereof. Attachment means for releasably attaching garment pieces together are well known in the art and the specific attachment means for the present Medical Pet Garment 1 can be modified from the means disclosed herein without departing from the spirit and scope of the present disclosure.

Further, the attachment means 14, 15, 19, 16, 10 disclosed herein may be all the same type of attachment means or a combination of different types of attachment means. In the example of FIGS. 1-9, attachment means 14, 15, 19, 16, 10 are snap buttons arranged in such manner that attachment means 16 can be releasably attached to attachment means 14, or attachment means 15, when the Medical Pet Garment 1 is in closed configuration, and attachment means 19 can be releasably attached to attachment means 10 when the Medical Pet Garment is in an open configuration. However, for example, attachment means 19 and 10 may be of a hook and loop closure, while attachment means 14, 15, and 16 are snap buttons. Indeed, one skilled in the art will appreciate that any attachment means, and any combination of attachment means, is within the scope of the present disclosure as long as attachment means 14, 15 can be releasably attached to attachment means 16, and attachment means 19 can be releasably attached to attachment means 10.

In some embodiments, the hindquarters flap 6 further comprises a tail opening 2 for receiving a pet's tail when the Medical Pet Garment 1 is worn by a pet and is in a closed configuration. In some other embodiments (not shown), the hindquarters flap 6 does not comprise a tail opening and is designed as two elongated pieces comprising a gap in-between them. The hindquarters flap 6 may then be used, and releasably attach as desired, in the same manner described herein, while the said gap, instead of the tail opening 2, provides an access for the animal's tail.

In some embodiments, the Medical Pet Garment 1 further comprises a pocket 7. The pocket 7 is positioned at an inner side of the Medical Pet Garment 1, wherein the inner side of the Medical Pet Garment 1 is the side facing the animal's body when the Medical Pet Garment 1 is in use, in a closed or an open configuration. The pocket 7 will be further discussed below.

The presently disclosed Medical Pet Garment 1 is generally fashioned out of any suitable fabric. For example, the fabric employed may be a knit, woven, a non-woven fabric, and combinations thereof. Furthermore, the fabric employed may be, for example, a light-weight fabric for comfort, a thick fabric for warmth, a water repellant/resistant fabric to protect from rain, a stretchable fabric for a tight fit, and combination thereof. One skilled in the art will appreciate that any suitable and known in the art fabric may be used for the purpose of the presently disclosed Medical Pet Garment 1, and that there is no intention of limiting the fabrics to those mentioned herein.

In some embodiments, those area of the Medical Pet Garment 1 which comprise attachment means 14, 15, 19, 16, 10 are reinforced to provide structural strength which promotes durability of the Medical Pet Garment 1 as the hindquarters flap 6 is put to use being releasably attached or detached. In some embodiments (illustrated in FIGS. 1 and 2), the reinforcement 9 comprises doubling of the fabric in the said areas. In other embodiments, the reinforcement 9 comprises a usage of a tick, strong, and/or resilient fabric in the areas of the Medical Pet Garment 1 which comprise attachment means 14, 15, 19, 16, 10.

Attaching together fabric to construct any part of the Medical Pet Garment 1, for example reinforcement 9 to the neck opening 4 area or to the hindquarters flap 6, may be done using any method traditional in the art for attaching pieces of fabric together. Examples of methods which may be employed for this purpose include sewing 12 (illustrated in at least FIGS. 1 and 2), gluing, welding, and combinations thereof.

In some embodiments, edges of the Medical Pet Garment 1, such as edges around the front legs, tail, and neck openings 3, 2, 4, edge of the top part 18, and edges of the hindquarters flap 6 distal to the bottom part 17 comprise a trim 13. The trim 13 serves a decorative and/or structural purpose and may be any fabric trim traditional in the art. Non limiting examples of a trim 13 include piping (illustrated in at least FIGS. 1 and 2), fringe, edging (such as, selvedge), sewing trim, lining, interlinings, hem, and combinations thereof.

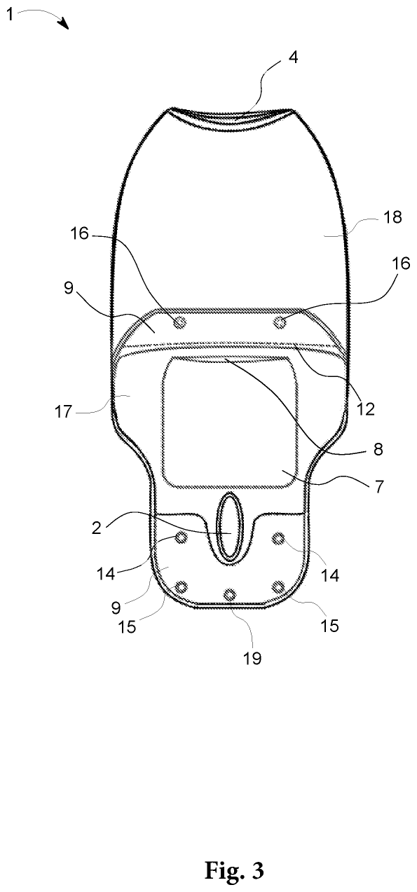

FIG. 3 illustrates a top view of the Medical Pet Garment 1 laid flat wherein part of the top part 18 is folded back to expose the optional pocket 7 and the pocket opening 8. Many times, a pet undergoing a medical procedure, or suffering from a medical condition, requires soothing or medicating. Examples of such medical procedures or conditions include, but not limited to, spaying, neutering, rashes, and hot spots. However, affixing a bandage on a pet and securing it in place is a challenge. Likewise, applying a medication to an exposed pet skin area is problematic because the pet might scratch or lick it off.

The pocket 7 solves these problems as it is useful for holding, for example, cold/hot compresses, gauze pads, gauze pads doused with medication, padding, etc. In some embodiments, the pocket is positioned substantially on the inner side of the hindquarters flap 6. In some other embodiments, the pocket is positioned partly on the inner side of the hindquarters flap 6 and partly on the inner part of the bottom part 17 (shown). In yet other embodiments, the pocket is positioned anywhere on the inner side of the bottom part 17, or anywhere on the inner side of the top part 18, as needed. The pocket 7 may be of any size and shape as long as it fits on the desired area of the inner side of the Medical Pet Garment 1.

In some embodiments, the pocket 7 is constructed into to the Medical Pet Garment 1, for example, by sewing, gluing, welding, and combinations thereof. In some other embodiments, the pocket is attached to the Medical Pet Garment 1 releasably using any suitable releasable attachment means including hook or loop fasteners, hook and eye, zippers, studs, fastening buttons and complementary button holes, straps with longitudinally spaced holes and corresponding buckles, snap buttons, and combinations thereof.

In some embodiments, the pocket 7 is opened 8 toward the direction of the neck opening 4 (shown). In some other embodiments, the pocket opening 8 opens toward the tail opening 2. In yet other embodiments, the pocket opening 8 opens toward a flank of the pet.

In some embodiments, the pocket opening 8 is closable. Means for reversibly closing a pocket are well known in the art and include, without limitation, hook or loop fasteners, hook and eye fasteners, zippers, studs, fastening buttons and complementary button holes, and corresponding buckles, or snap buttons.

In yet other embodiments, an inner side of the pocket 7, the side which faces the animal's body when Medical Pet Garment 1 is in use, comprises liquid permeable fabric, for example, mesh fabric, to allow contact of a medication with the pet's skin.

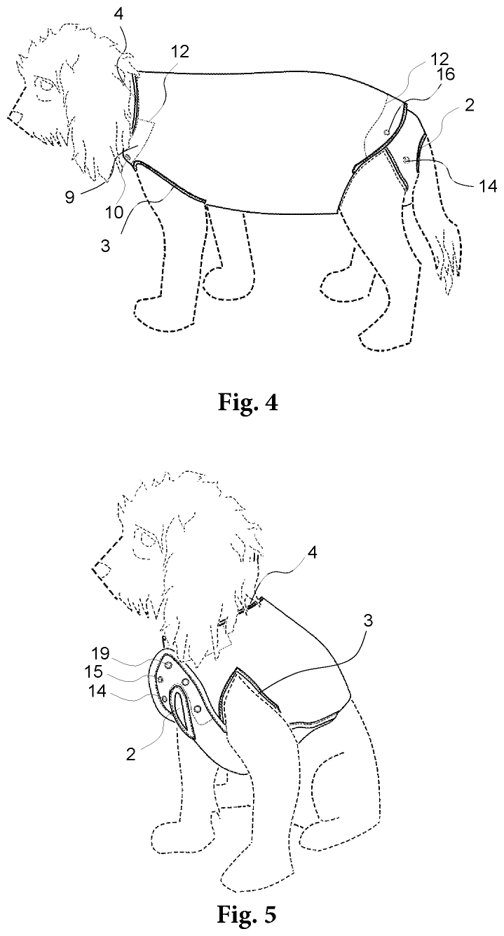

FIGS. 4 and 5 illustrate the Medical Pet Garment 1 while in use. In the example illustrated in FIGS. 4 and 5 the Medical Pet Garment 1 is worn by a dog. Specifically, FIG. 5 depicts the Medical Pet Garment 1 in use and in a first closed configuration.

Dressing a pet with the Medical Pet Garment 1 comprises passing the pet's head through the neck opening 4 and positioning the top part 18 at the pet's back and the bottom part 17 at the pet's chest. A user then passes each of the pet's front legs through the front leg opening 3. If a closed configuration of the Medical Pet Garment 1 is desired, a user passes the pet's tail through the tail opening 2 and releasably attaches the hindquarters flap's attachment means 14 or 15 to the attachment means 16 positioned on top part 18, thereby covering the pet's abdomen and rump.

In the example illustrated in FIG. 4, attachment means 15 are used for the releasable attachment to the top part 18. Since attachment means 15 are closer to the end of the hindquarters flap 6 which is distal to the bottom part 17 than attachment means 14, this means that the Medical Pet Garment 1 when in a first closed configuration is at its maximal closed size. The said maximal closed size may be a good fit for a bigger pet. If attachment means 14 are used for the releasable attachment to the top part 18, then the Medical Pet Garment 1 would be in a second closed configuration and in a smaller closed size. The said smaller closed size may be a good fit for a smaller pet. Since, as discussed above, the Medical Pet Garment 1 may comprise more than two sets of attachment means 14, 15, it is expressly contemplated herein that closed configurations 3, 4, 5 . . . , each representing a different closed size of the Medical Pet Garment 1, are within the scope of the present disclosure.

When desired to expose the pet's abdomen and rump, for example, to allow a pet to urinate/defecate or allow a user to attend to a wound or a treated area, a user has to simply release the hindquarters flap 6 from the attachment to the top part 18, and pull it away from its position in between the pet's hind legs. The user then may position it so that it lies flat against the outer side of the bottom part 17, and releasably secure it, via attachment means 19, to the bottom part's attachment means 10 positioned proximal to the neck opening, as shown in FIG. 5. The action of releasably attaching the hindquarters flap 6 to the bottom part's attachment means 10 is basically a convenient one step process, which presents a huge advantage to an owner of a convalescing pet. A user does not have to fold the hindquarters flap 6 in a certain way, or roll it, in order to expose attachment means 19 and be able to secure it to the bottom part's attachment means 10, but simply a user has to swing hindquarters flap 6 to the chest area of the pet and easily attach it there.

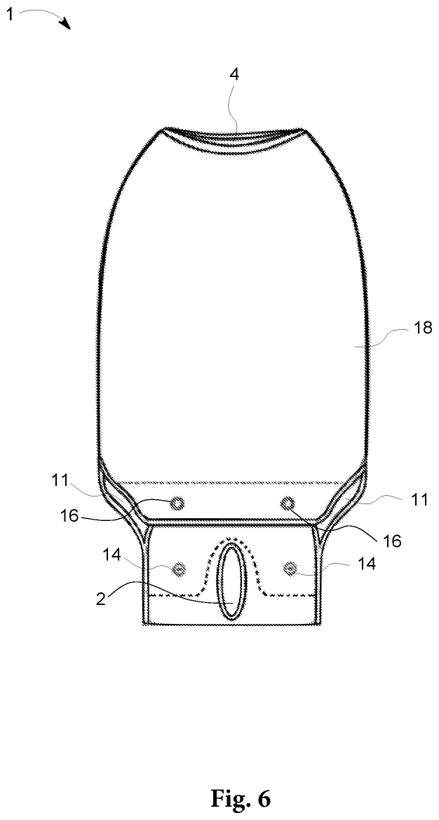

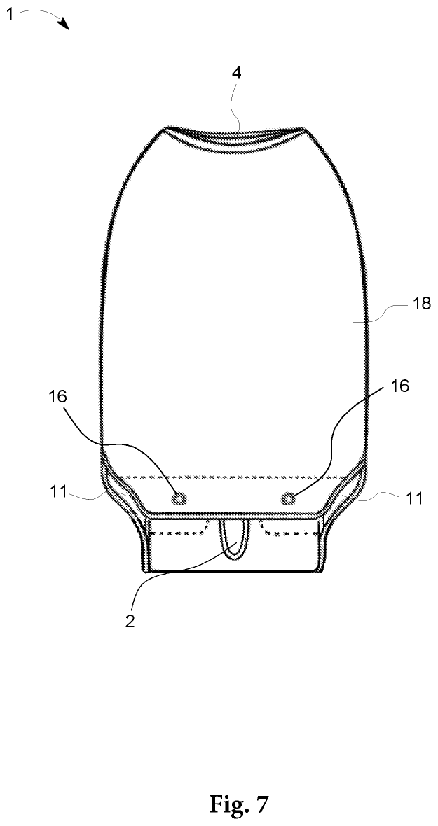

Referring now to FIGS. 6 and 7, FIG. 6 is a top view of the Medical Pet Garment 1 in a first closed configuration, wherein attachment means 15 are used for the releasable attachment to the top part 18, thereby defining a maximal closed size of the Medical Pet Garment 1. FIG. 7 is a top view of the Medical Pet Garment 1 in a second closed configuration, wherein attachment means 14 are used for the releasable attachment to the top part 18, thereby defining a smaller closed size of the Medical Pet Garment 1.

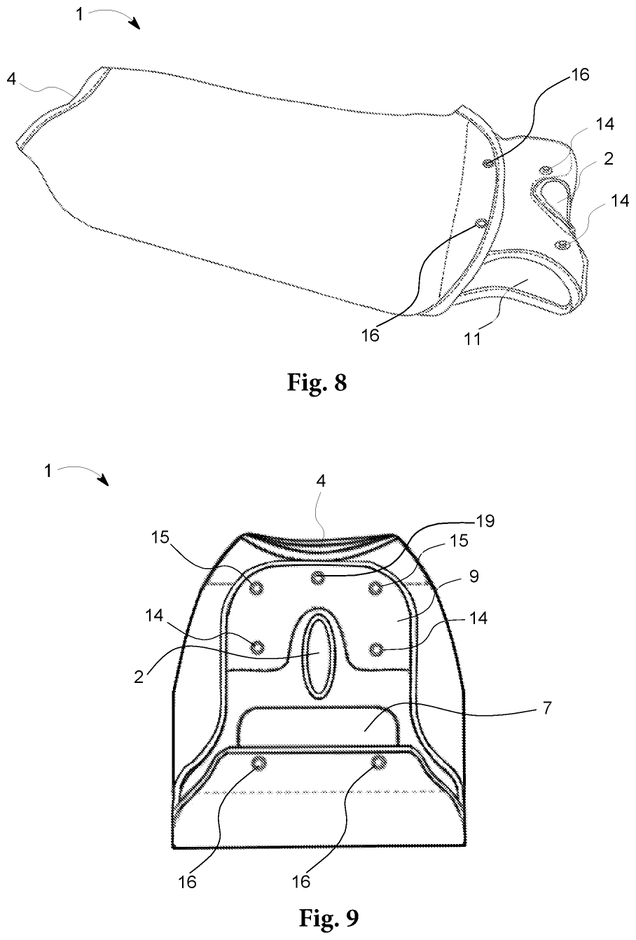

FIG. 8 illustrates a perspective view of the example of FIGS. 1-6, wherein the Medical Pet Garment 1 is in a first closed configuration. When the hindquarters flap 6 is positioned upon the pet's abdomen and between its hindlegs and is attached to the top part in a chosen closed configuration, comfortable and fitted openings 11 are thereby created for the pet's hind legs.

Finally, FIG. 9 illustrates a bottom view of the example of FIGS. 1-7 wherein the Medical Pet Garment 1 is laid flat and the hindquarters flap lays against the bottom part 17 and possibly releasably secured to the bottom part via attachment means 19 and 10. Attachment means 14, 15 are illustrated, and the partly folded top part 18 depicts attachment means 16.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments, ±100% in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide. For example, when using the term “substantially” herein it may be a value of at least 50%, at least 60%, at least 70%, at least 80%, at least 90%, or at least 99%, or any amount or range therebetween.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A medical pet garment for a quadruped pet comprising an upper torso portion and a hindquarters flap;
wherein the upper torso portion is designed to substantially cover a back and a chest of a pet;
wherein the upper torso portion comprises a bottom part and a top part, the bottom part and the top part formed as one piece, and wherein the bottom part substantially covers the chest of a pet and the top part substantially covers the back of a pet.
wherein the upper torso portion comprises a neck opening designed to receive a neck of a pet, and at least one front leg opening designed to receive at least one front leg of a pet;
wherein the hindquarters flap extends from an end of the bottom part distal, and opposite, to the neck opening;
wherein the upper torso portion further comprises at least one attachment means positioned substantially at an end of the top part distal, and opposite, to the neck opening;
wherein the hindquarters flap comprises at least one attachment means positioned substantially at an end of the hindquarters flap distal to the bottom part;
wherein the hindquarters flap is designed to be positioned over a pet's abdomen, in between a pet's hindlegs, and over a pet's rump, and releasably attach via the at least one hindquarters flap's attachment means to the upper torso portion's at least one attachment means, thereby covering a pet's abdomen and rump; and,
wherein an inner side of the Medical Pet Garment is the side facing the pet's body when the Medical Pet Garment is worn by a pet.

2. The Medical Pet Garment of claim 1, wherein the bottom part further comprises at least one attachment means positioned proximal to the neck opening, and wherein the hindquarters flap is further designed to be positioned against the bottom part in such manner that an outer surface of the hindquarters flap is positioned against an outer surface of the bottom part, and releasably attach via the hindquarters flap's at least one attachment means to the said at least one attachment means positioned proximal to the neck opening, thereby leaving the pet's abdomen and rump exposed.

3. The Medical Pet Garment of claim 2, wherein the hindquarters flap further comprises a tail opening designed to receive a pet's tail.

4. The Medical Pet Garment of claim 3, wherein the hindquarters flap comprises at least two sets of attachment means, wherein each set comprises at least one attachment means designed for releasable attachment to the top part; wherein each set is positioned at a different, predetermined, distance from the end of the hindquarters flap distal to the bottom part; and wherein when the Medical Pet Garment is worn by a pet, each set, from closest to farthest from the said end of the hindquarters flap, when used to releasably attach the hindquarters flap to the top part, defines a different size of the Medical Pet Garment, from biggest to smallest, respectively.

5. The Medical Pet Garment of claim 4, wherein the bottom part comprises one attachment means positioned proximal to the neck opening, and the top part comprises two attachment means positioned substantially at the end of the top part distal to the neck opening.

6. The Medical Pet Garment of claim 5, wherein the hindquarters flap comprises two sets of attachment means designed for releasable attachment to the top part, wherein each set is positioned at a different, predetermined, distance from the end of the hindquarters flap distal to the bottom part, and wherein each set comprises two attachment means; and, wherein the hindquarters flap further comprises one attachment means designed for releasable attachment to the bottom part's attachment means positioned proximal to the neck opening.

7. The Medical Pet Garment of claim 6, wherein the Medical Pet Garment further comprises a closable pocket positioned on its inner surface.

8. The Medical Pet Garment of claim 7, wherein the pocket is positioned substantially on the inner surface of the hindquarters flap.

9. The Medical Pet Garment of claim 8, wherein the attachment means is selected from a group comprising hook or loop fasteners, hook and eye fasteners, zippers, studs, fastening buttons and complementary button holes, straps with longitudinally spaced holes and corresponding buckles, snap buttons, and combinations thereof.

10. A method of using the Medical Pet Garment of claim 9, the method comprises the steps of:
(a) passing a pet's head through the neck opening and positioning the top part at the pet's back and the bottom part at the pet's chest;
(b) passing each pet's front legs through the at least one front leg opening;
(c) positioning the hindquarters flap over the pet's abdomen and in between the pet's hindlegs;
(d) passing a pet's tail through the tail opening;
(e) releasably attaching a set of the hindquarters flap's attachment means to the top part's two attachment means; and,
(f) when desired, releasing the hindquarters flap from the top part's two attachment means and releasably attaching the hindquarters flap to the bottom part's attachment means positioned proximal to the neck opening, thereby exposing the pet's abdomen and rump.
